(19) United States
(12) Patent Application Publication
(10) Pub. No.: US 2014/0299439 A1
(43) Pub. Date: Oct. 9, 2014

(54) ACTUATOR DEVICE FOR ACTUATING A COUPLING MECHANISM

(71) Applicants: Michael Weiss, Herzogenaurach (DE); Klaus Hahn, Obereichenbach (DE)

(72) Inventors: Michael Weiss, Herzogenaurach (DE); Klaus Hahn, Obereichenbach (DE)

(73) Assignee: Schaeffler Technologies GmbH & Co. KG, Herzogenaurach (DE)

(21) Appl. No.: 14/363,119

(22) PCT Filed: Aug. 9, 2012
(86) PCT No.: PCT/EP2012/065577

§ 371 Date: Jun. 5, 2014

(30) Foreign Application Priority Data
Dec. 15, 2011 (DE) 10 2011 088 672.9

(51) Int. Cl. F16D 25/06

(52) U.S. Cl. CPC F16D 25/06
USPC 192/85.17

(57) ABSTRACT

An actuator device for actuating a coupling mechanism or a transmission in a drive wheel in a belt drive or chain drive, includes a shaft, releasably connectable to the drive wheel and at least partially hollow, a push rod connected to the coupling mechanism or transmission and displaceable coaxially to the longitudinal axis of the shaft, a housing having an internal bore for at least partially receiving the shaft, and at least one first bearing disposed in the internal bore of the housing for rotatably supporting the shaft. The actuator device constitutes a fluidic actuator having at least one first pressure chamber capable of being pressurized with a fluid.

The present invention relates to an actuator device for actuating a coupling mechanism or a transmission in a drive wheel in a chain drive or belt drive, in particular of a controllable coolant pump for an internal combustion engine.

### BACKGROUND

Water-cooled engines have become predominant in the field of internal combustion engines. In such engines, cooling water is pumped by a coolant pump in a closed loop through cooling passages in the region of the cylinders in order to cool the internal combustion engine, and is then conveyed to an air/water radiator, where the heated water is cooled down by the relative wind generated by the motion of the vehicle. The pump required to circulate the water is typically connected by a belt drive and/or a chain drive to a pulley of the crankshaft of the internal combustion engine.

Since the coolant pump is directly coupled to the crankshaft, the rotational speed of the pump is dependent on the rotational speed of the internal combustion engine. As a result, in the high speed range of the internal combustion engine, the pump delivers a correspondingly high flow rate, which exceeds that required for cooling. However, during cold starting of the internal combustion engine, the problem arises that coolant is immediately circulated through the cooling passages, thereby hindering the heating of the combustion chambers and delaying the attainment of an optimum operating temperature.

A controllable coolant pump of the aforementioned type is known from German Patent Application DE 2008 046 424 A1. In this publication, a guide plate having a contour corresponding to the impeller is disposed between the impeller and a cover plate, the guide plate being guided by the axial webs connecting the impeller and the cover plate, and being axially displaceable by an actuation unit by means of a piston placed within the hollow shaft. By placing a guide plate between the impeller and the cover plate and axially displacing the same by means of a piston guided within the hollow shaft, it is possible to vary the flow rate of the coolant pump.

The drawback here is that when the drive wheel is driven, the impeller rotates as well, even when cooling of the engine is not yet desired. This is because the drive wheel is connected directly to the crankshaft.

### SUMMARY OF THE INVENTION

It is an object of the present invention to provide a cost-effective, space-optimized actuator device for actuating a coupling mechanism or a transmission for coupling or uncoupling a drive wheel in a belt drive or chain drive.

The actuator device for actuating a coupling mechanism or a transmission in a drive wheel in a belt drive or chain drive, in particular of a controllable coolant pump for an internal combustion engine, includes a shaft, having a longitudinal axis, which is releasably connectable to the drive wheel and is at least partially hollow, a push rod which is connected to the coupling mechanism or transmission and is displaceable coaxially to the longitudinal axis of the shaft, a housing having an internal bore for at least partially receiving the shaft, and at least one first bearing disposed in the internal bore of the housing for rotatably supporting the shaft. In accordance with the present invention, the actuator device constitutes a fluidic actuator having at least one first pressure chamber capable of being pressurized with a fluid.

The controllable coolant pump is drivable via a drive wheel, which can be connected to the shaft at an end opposite the impeller. The impeller can have vanes extending into a suction chamber. Rotation of the impeller allows cooling water to be drawn into the suction chamber through an intake port of the housing of the coolant pump and to be conveyed by the vanes into an annular channel of the pump housing. The guide plate is axially displaceable by a push rod at least partially disposed within the hollow shaft, whereby it is possible to vary the pumping volume of the suction chamber of the coolant pump. The shaft of the actuator device extends along a longitudinal axis and may be completely or partially hollow. Moreover, the shaft can be releasably connected at one end to a drive wheel. The shaft and the drive wheel can be designed to be releasably connectable to each other by a coupling mechanism. The push rod may be disposed within the shaft, partially within the shaft, or substantially outside the shaft in coaxial relationship with the longitudinal axis of the shaft. At the end opposite the drive wheel, the shaft is disposed at least partially within the housing having an internal bore. The internal bore may have at least one first bearing point for receiving a first bearing disposed in the internal bore of the housing for rotatably supporting the shaft. The internal bore may have a second bearing at a second bearing point for rotatably supporting the shaft. The first bearing and the second bearing may be axially spaced apart from each other. The coupling mechanism between the drive wheel and the shaft may, for example, take the form of a draw-key coupling capable of being actuated by the push rod. The draw-key coupling may have a draw key which may be connected to the push rod. The draw key is axially movable along the longitudinal axis of the shaft between a first position and a second position. In the first position, the shaft is connected to the drive wheel, while in the second position, the drive wheel and the shaft are uncoupled. Thus, in the first position, pumping of cooling water is possible, while in the second position, the drive wheel can rotate independently of the shaft, which may be standing still, so that no pumping of cooling water is possible. The drive wheel of the actuator device may, for example, take the form of a pulley in a belt drive or a gear wheel, for example, in a transmission. The shaft may, for example, by a pump shaft of, for example, a coolant pump for an internal combustion engine or a transmission shaft of a transmission. In accordance with the present invention, the actuator device constitutes a fluidic, in particular hydraulic, actuator forming at least one first pressure chamber. The at least one first pressure chamber can be pressurized with a fluid. The pressure applied may be either positive or negative with respect to atmospheric pressure. The actuator device according to the present invention enables actuation of a coupling mechanism or a transmission in a drive wheel in a belt or chain drive, allowing the drive wheel to be uncoupled from the rotating crankshaft wheel, as a result of which the shaft does not rotate, and thus the impeller connected to the shaft also does not rotate. The makes it possible to reduce the power requirements and also enables faster heating of an internal combustion engine during cold starting because no water is pumped through the system by the coolant pump. In particular, by designing the actuator device as a fluidic actuator, it is possible to provide an actuator for actuating a coupling mechanism which is optimized in terms of weight, space, and energy requirements.

In a preferred embodiment of the present invention, an annular seal and a movable sealing ring axially spaced therefrom are provided in the internal bore, an annular variable first pressure chamber being formed between the seal, the sealing ring, the shaft, and the housing. The annular seal may bear against the first bearing on the inside. The sealing ring, which surrounds the shaft and may bear against the inner wall of internal bore, is axially spaced apart from the annular seal and movable in the axial direction. An annular variable first pressure chamber is formed axially between the annular movable sealing ring and the annular seal and is bounded radially between the shaft and the inner surface of the internal bore of the housing. The pressure chamber extends annularly around the shaft and is variable in the axial direction. The sealing ring can be axially displaced by a fluid entering the first pressure chamber, thereby allowing the first pressure chamber to be enlarged in the axial direction. The sealing ring may be connected to the push rod, which may be provided within the hollow shaft, whereby an axial movement of the sealing ring can be transmitted to the push rod. Thus, the coupling mechanism, in particular the draw-key coupling, can be actuated the push rod. The volume of the pressure chamber can be varied, in particular in the axial direction, as a function of the volume and pressure of the fluid that is introduced into the pressure chamber. Preferably, the push rod, which is at least partially disposed within the shaft, has a transmission element which contacts the sealing ring through at least one opening formed in the shaft. In order to transmit the axial movement of the sealing ring to the push rod, the push rod has a transmission element which contacts the sealing ring through at least one opening formed in the shaft. The transmission element may take the form of a transverse pin. The transverse pin may extend substantially perpendicularly to the longitudinal axis of the push rod and contacts the sealing ring through at least one opening of the shaft, preferably through two openings of the shaft. The transmission element may be permanently or detachably connected to the sealing ring. The at least one opening in the shaft is formed in the wall of the shaft in the region where the shaft is hollow. The opening may be configured as a slotted hole to allow axial movement of the transmission element. The at least one opening may be sealed axially by the sealing ring from the fluid of the pressure chamber, for example by axial overlapping. The transmission element makes it possible to reliably connect the sealing ring to the push rod to transmit motion.

Particularly preferably, the push rod has a first push rod shoulder at a first end disposed within the shaft, and the shaft has formed therein a first shaft shoulder through which extends the push rod, a first annular variable pressure chamber being formed between the first push rod shoulder, the first shaft shoulder, the push rod, and the shaft. The push rod has a first end disposed within the shaft and a second end which is opposite the first end and may be located on the drive wheel side. The push rod has a first push rod shoulder at the first end. This push rod shoulder may be configured as a circular disk at the end of the push rod, and in such a way that it completely fills the diameter of the bore within the shaft, in particular the hollow shaft. A first shaft shoulder is disposed within the shaft, in particular the hollow shaft, at an axial distance from the first push rod shoulder. The push rod extends, in particular centrally, through the first shaft shoulder. A first pressure chamber is bounded axially between the first push rod shoulder and the first shaft shoulder, and radially by the inner wall of the hollow shaft and the surface of the push rod. The first push rod shoulder, or more specifically, the push rod with the first push rod shoulder, is disposed like a piston within the hollow shaft and can be axially moved like a slide valve. The movement of the push rod can be caused by pressurizing the first pressure chamber with a fluid. The first shaft shoulder may be formed as an annular insert within the at least partially hollow shaft. The annular insert has an opening for extension of the push rod therethrough. By forming the first pressure chamber of the actuator device within a hollow portion of the shaft, the space required for the actuator device can be further reduced.

In a preferred embodiment, the push rod has a second push rod shoulder, and the shaft has formed therein a second shaft shoulder through which extends the push rod, a second annular variable pressure chamber being formed between the second push rod shoulder, the second shaft shoulder, the push rod, and the shaft. The second push rod shoulder of the push rod may be axially spaced apart from the first push rod shoulder in a direction toward the second end of the push rod. The second push rod shoulder may take the form of an annular disk having a diameter substantially equal to the inner diameter of the hollow portion of the shaft. The second shaft shoulder of the shaft may be located toward the second end of the push rod. The second shaft shoulder may be formed as an annular insert within the hollow shaft and has an opening for extension of the push rod therethrough. A second pressure chamber may be bounded axially between the second push rod shoulder and the second shaft shoulder, and radially by the inner surface of the hollow shaft and the push rod. The second pressure chamber may be formed at an axial distance from the first pressure chamber. The first and second pressure chambers may be designed to act equally or differently, for example through control by means of a 4/2 way valve. By incorporating a second pressure chamber within the hollow shaft of the actuator device, it is possible to produce a greater force for actuating a coupling mechanism within the same space and/or to enable the push rod to move in both axial directions.

In one embodiment, an actuator housing is provided which is disposed on the side of the drive wheel facing away from the housing and has an opening for at least partially receiving the push rod. The actuator housing, together with the push rod, forms a first pressure chamber therein. The actuator housing may be in the form of a cylinder capable of at least partially receiving the push rod. The push rod may be disposed within the actuator housing in the manner of a piston. The push rod may have a first push rod shoulder within the actuator housing. The actuator housing is disposed on the side of the drive wheel facing away from the housing, and the second end of the push rod may be at least partially received within the actuator housing in the manner of a piston. The push rod, or more specifically, the face of the second end of the push rod, together with the actuator housing, may form a first pressure chamber capable of being pressurized with a fluid, whereby the push rod can be caused to move axially in the manner of a piston, thereby allowing actuation of the coupling mechanism. By disposing the actuator housing on the side of the drive wheel facing away from the housing, the space required for the coolant pump on the housing side can be further reduced.

Preferably, the actuator housing and/or the shaft has/have at least one first bore allowing fluid passage therethrough for supplying and/or discharging the fluid. The housing and/or the actuator housing has at least one first bore allowing fluid passage therethrough, which bore allows a fluid to be supplied to and/or discharged from a first pressure chamber. The housing and/or the actuator housing may have at least one second bore for supplying and/or discharging a fluid for a second pressure chamber. The first and/or second pressure chambers can be pressurized with a fluid through the first and/or second bores. The fluid can also be discharged from the first and/or second pressure chambers through the first and/or second bores. In particular in the case of a pressure chamber disposed within the shaft, the first and/or second bores may extend through the wall of the hollow shaft. Thus, the first and/or second pressure chambers within the hollow portion of the shaft can be connected to the respective first and/or second bores within the housing. This allows a pressure chamber disposed within the shaft to be pressurized with a fluid. The housing, the actuator housing and/or the shaft may have a drain bore allowing a region that is not pressurized with the fluid to be connected to the environment, for example, to a reservoir. This allows any fluid leakage to be removed from the actuator device, thereby enabling the actuator device to function smoothly. The housing may have a shoulder in the internal bore at least on one side thereof, which shoulder extends radially inwardly toward the shaft and may contact the shaft at its radially outer surface. A bore may extend through the housing, the shoulder, and the shaft, thereby enabling a fluid connection to be established between the housing and a pressure chamber. The shoulder may for example be disposed between the first bearing and the second bearing and extend radially inwardly.

Particularly preferably, a spring element is provided for actuating the push rod, the spring element being disposed between the push rod and the shaft or the actuator housing. The spring element for actuating the push rod may be a tension or compression spring. The spring element may be disposed between the push rod and the shaft and/or the actuator housing in a manner ensuring that the push rod can be retracted, for example, in response to a decrease in pressure. The spring element may be configured and disposed as a fail-safe device, so that the push rod can be moved to the first position by the spring element in response to a failure in fluid pressure. Thus, in the event of a failure in fluid pressure, it can be ensured that the coupling mechanism will be engaged, and thus, that the coolant will be pumped by the coolant pump.

The present invention further relates to a coupling mechanism in a drive wheel in a belt drive or chain drive, including an actuator device embodied and refined as described above. By designing the actuator device as a fluidic actuator, it is possible to provide an actuator for actuating a coupling mechanism, which is optimized in terms of weight, space, and energy requirements.

The present invention also relates to a pump, in particular a coolant pump, for a motor vehicle and/or internal combustion engine, having an actuator device embodied and refined as described above, as well as a coupling mechanism embodied and refined as described above. By designing the actuator device as a fluidic actuator, it is possible to provide a pump, in particular a coolant pump, which is optimized in terms of weight, space, and energy requirements.

### BRIEF DESCRIPTION OF THE DRAWINGS

The present invention will now be illustrated with reference to preferred exemplary embodiments and the accompanying drawings, in which:

FIG. 1 is a schematic sectional view of an actuator device according to the present invention;

FIG. 2 is a schematic sectional view of an actuator device having a pressure chamber incorporated in a shaft;

FIG. 3 is a schematic sectional view of an actuator device having a first and a second pressure chamber;

FIG. 4 is a schematic sectional view of an actuator housing.

### DETAILED DESCRIPTION

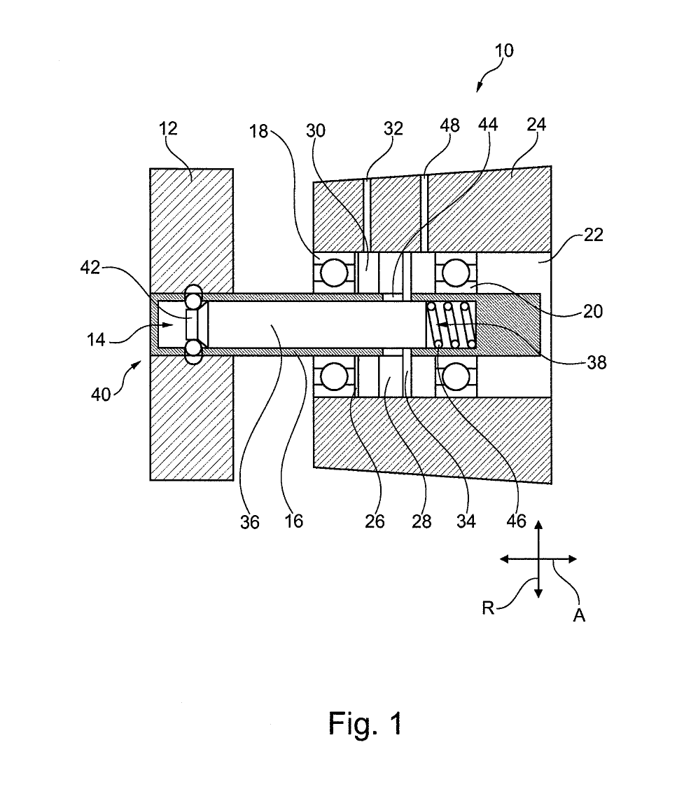

The actuator device 10 shown in FIG. 1 has a drive wheel 12 which is non-rotatably connectable to a shaft 16 via a coupling mechanism 14, such as a draw-key coupling. Coupling mechanism 14 is shown in an open condition, a first position, in which drive wheel 12 is rotatable independently of shaft 16. Shaft 16 is at least partially hollow and closed at both ends. Shaft 16 is rotatably supported in an internal bore 22 of a housing 24 via a first bearing 18 and a second bearing 20 in the form of ball bearings. An annular seal 26 is disposed within the internal bore at first bearing 18, and a sealing ring 28 is disposed within the internal bore at an axial distance from annular seal 26. Annular seal 26 and sealing ring 28 are in contact with shaft 16 at their radially inner peripheries and with housing 24 at their radially outer peripheries. A first pressure chamber 30 is bounded axially by annular seal 26 and sealing ring 28, and radially between shaft 16 and the inner surface of housing 24. First pressure chamber 30 can be pressurized, e.g., with a fluid, in particular a liquid or a gas, through a first bore 32 formed in housing 24. Pressurizing first pressure chamber 30 with a fluid can cause sealing ring 28 to move axially, thereby allowing first pressure chamber 30 to be enlarged. The axial movement of sealing ring 28 can be transmitted to a push rod 36 via a transmission element 34 connected to push rod 36. Push rod 36 is disposed within the at least partially hollow shaft 16. Push rod 36 is axially movably within shaft 16 in coaxial relationship therewith. Push rod 36 has a first end 38, which is located on the housing side and connected to transmission element 34, e.g., a transverse pin. The push rod has a second end 40 opposite its first end 38. The second end is located on the drive wheel side and has, for example, a draw key 42 of coupling mechanism 14, which takes the form of a draw-key coupling. Transmission element 34 projects substantially perpendicularly from push rod 36 on opposite first and second sides. Transmission element 34 extends through openings 44 in the wall of hollow shaft 16 and contacts sealing ring 28. Disposed between first push rod end 38 and shaft 16 is a spring element 46, e.g., a compression spring, which, in the event of a drop or decrease in pressure, moves push rod 36 axially from a second position, in which coupling mechanism 14 is disengaged, to a first position, whereby coupling mechanism 14 non-rotatably connects shaft 16 to drive wheel 12. Housing 24 has a drain bore 48 between second bearing 20 and sealing ring 28, allowing any leakage, in particular leakage of the fluid of first pressure chamber 30, to be removed therethrough from internal bore 22 and housing 24.

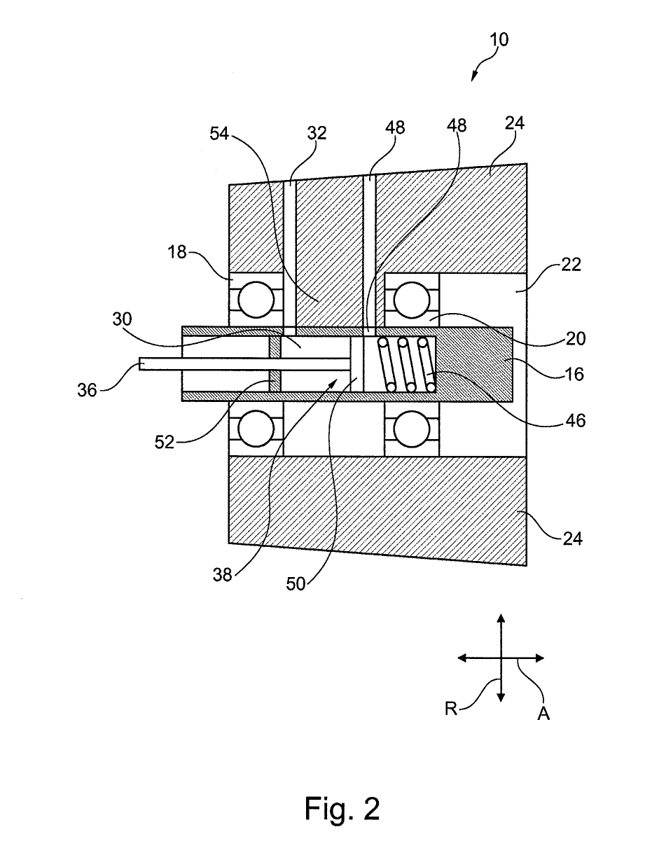

FIG. 2 shows an actuator device 10 having a first pressure chamber 30 incorporated in shaft 16. The push rod 36 disposed within hollow shaft 16 has at its first end 38 a first push rod shoulder 50. First push rod shoulder 50 is configured as an annular disk-shaped surface at the end face of push rod 36. First push rod shoulder 50 is supported against shaft 16 via spring element 46. A first shaft shoulder 52 is formed toward second push rod end 40 within shaft 16, which is hollow in this region. First shaft shoulder 52 has an opening for receiving push rod 36 and is configured substantially as an annular disk. First pressure chamber 30 is formed between first shaft shoulder 52 and first push rod shoulder 50 and is bounded radially by shaft 16 and push rod 36. Shaft 16 is rotatably supported within housing 24 in first bearing 18 and second bearing 20. Housing 24 has a shoulder 54 between first bearing 18 and second bearing 20. Shoulder 54 extends radially inwardly to shaft 16 and contacts shaft 16. First bore 32 and drain bore 48 are formed within housing 24 and shoulder 54. First bore 32 and drain bore 48 extend through shoulder 54 to shaft 16, where first bore 32 and drain bore 48 are formed correspondingly in the wall of shaft 16, which is hollow in this region. Pressure chamber 30 can be pressurized with a fluid through first bore 32, which is formed in housing 24, or more specifically, in shoulder 54 of housing 24, and the wall of shaft 16. First bore 32 serves as an inlet to pressure chamber 30 and as an outlet therefrom for the fluid. Drain bore 48 opens into a region between first push rod shoulder 50 and shaft 16 in the area of spring element 46, whereby any fluid leakage that may occur from first pressure chamber 30 in the direction of first push rod shoulder 50 can be removed from shaft 16 through drain bore 48.

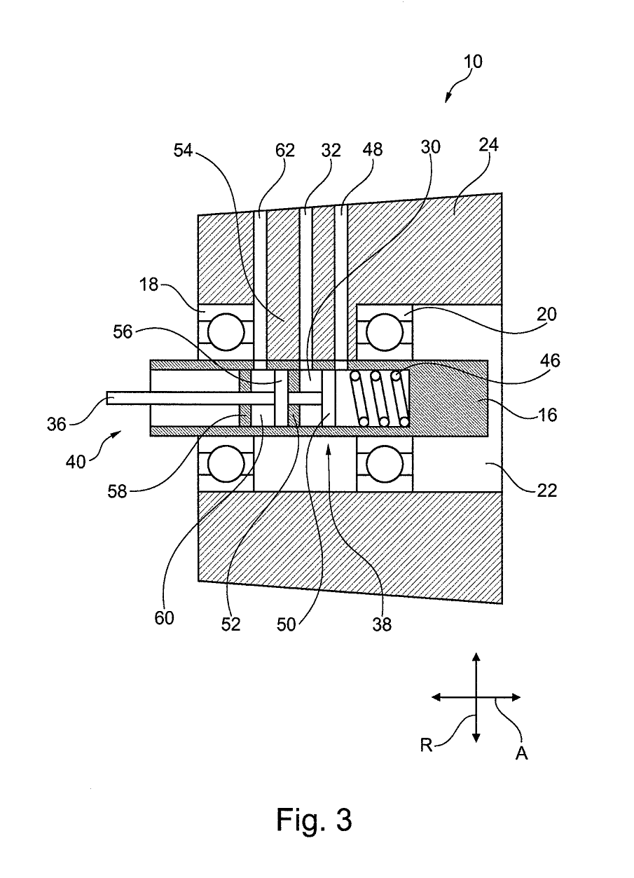

FIG. 3 shows an actuator device 10 similar to the one shown in FIG. 2. Actuator device 10 includes shaft 16 and push rod 36, and is rotatably supported in first bearing 18 and second bearing 20. Housing 24 has, between first and second bearings 18, 20, a shoulder 54 which extends radially into internal bore 22 and contacts shaft 16 at its radially outer surface. Next to drain bore 48, actuator device 10 has the first bore 32, through which a fluid can be supplied into first pressure chamber 30. First pressure chamber 30 is bounded axially by first push rod shoulder 50 and first shaft shoulder 52, and radially between shaft 16 and push rod 36. Push rod 36 has a second push rod shoulder 56 at an axial distance from first push rod shoulder 50, the second push rod shoulder being configured as an annular disk and axially spaced from first push rod shoulder 50 in a direction toward second end 40 of push rod 36.

Shaft 16 has a second shaft shoulder 58 at an axial distance from second push rod shoulder 56, the second shaft shoulder being axially spaced from second push rod shoulder 56 in a direction toward second push rod end 40. Second shaft shoulder 58 is configured as an annular disk, which has an opening for extension of push rod 36 therethrough. Second pressure chamber 60 is bounded axially between second push rod shoulder 56 and second shaft shoulder 58, and radially by shaft 16 and push rod 36. Second pressure chamber 60 can be pressurized with a fluid through a second bore 62 extending through housing 24, shoulder 54 of the housing 24, and the wall of shaft 16. The pressurization of first pressure chamber 30 and second pressure chamber 60 may be performed uniformly or non-uniformly, for example, alternatingly and oppositely. First pressure chamber 30 and second pressure chamber 60 are formed in succession in the axial direction by shaft shoulders 52, 58 and push rod shoulders 50, 56. First pressure chamber 30 and second pressure chamber 60 may be designed to act equally, so that when first pressure chamber 30 and second pressure chamber 60 are pressurized, push rod 36 can move in a direction toward first push rod end 38 and shaft 16. The push rod can be moved from a first locked position to a second unlocked position of coupling mechanism 14. Push rod can be moved axially by spring element 46 from the unlocked second position to the locked first position of coupling mechanism 14. Via drain bore 48, any leakage from the interior of shaft 16 can be discharged to the outside through housing 24, in particular via a drain bore 48 in shoulder 54.

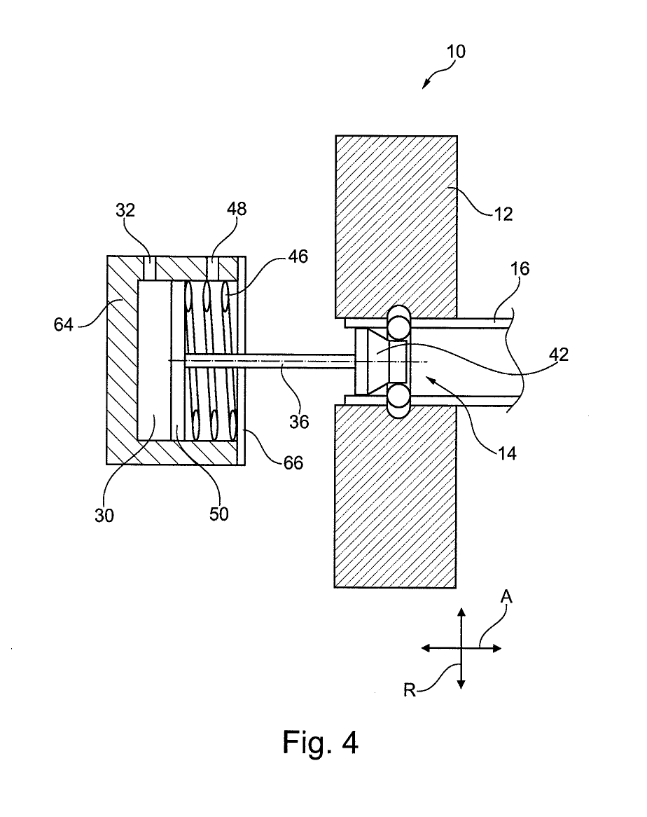

FIG. 4 shows an actuator device 10 having an actuator housing 64. Actuator housing 64 is disposed on the side of drive wheel 12 facing away from the housing (not shown). Actuator housing 64 is cylindrical in shape and receives push rod 36 in the manner of a piston. First push rod shoulder 50 of push rod 36 is disposed within actuator housing 64 and is configured as a circular disk.

First pressure chamber 30 is formed between first push rod shoulder 50 and actuator housing 64. Pressure chamber 30 can be pressurized with a fluid through first bore 32. Spring element 46 is formed around push rod 36 between first push rod shoulder 50 and a cover 66 of actuator housing 64. After pressurization, push rod 36 can be moved by spring element 46 axially, for example, back to the first position. On the drive wheel side, push rod 36 has a draw key 42 disposed within shaft 16, which is at least partially hollow and in which is disposed a coupling mechanism 14. Draw key 42 and push rod 36 are shown in the second, unlocked position, in which drive wheel 12 is rotatable independently of shaft 16. When pressure chamber 30 is pressurized with a fluid through first bore 32, push rod 36 may be moved axially toward drive wheel 12, whereby coupling mechanism 14, or more specifically, draw key 42, creates a non-rotatable connection between the shaft and drive wheel 12. In the event of a pressure drop or a negative pressure acting on pressure chamber 30, push rod 36 may be moved axially by spring element 46 to the second, unlocked position. The movement of push rod 36 to the second, unlocked position may be achieved by applying a negative pressure to pressure chamber 30 through first bore 32. Actuator housing 64 has a drain bore 48, which opens into actuator housing 64 in the region of spring element 46 between first push rod shoulder 50 and cover 66, whereby any fluid leakage can be discharged from actuator housing 64 from this region through drain bore 48.

### LIST OF REFERENCE NUMERALS

10 actuator device
12 drive wheel
14 coupling mechanism
16 shaft
18 first bearing
20 second bearing
22 internal bore
24 housing
26 annular seal
28 sealing ring
30 first pressure chamber
32 first bore
34 transmission element
36 push rod
38 first end
40 second end
42 draw key
44 opening
46 spring element
48 drain bore
50 first push rod shoulder
52 first shaft shoulder
54 shoulder
56 second push rod shoulder
58 second shaft shoulder
60 second pressure chamber
62 second bore
64 actuator housing
66 cover

1-10. (canceled)

11. An actuator device for actuating a coupling mechanism or a transmission in a drive wheel in a chain drive or belt drive for an internal combustion engine, the actuator device comprising:
a shaft having a longitudinal axis and releasably connectable to the drive wheel and being at least partially hollow;
a push rod connected to the coupling mechanism or the transmission and displaceable coaxially with respect to the longitudinal axis of the shaft;
a housing having an internal bore for at least partially receiving the shaft;
at least one first bearing disposed in the internal bore of the housing for rotatably supporting the shaft; and
a fluidic actuator having at least one first pressure chamber pressurizable with a fluid.

12. The actuator device as recited in claim 11 further comprising an annular seal and a movable sealing ring axially spaced therefrom in the internal bore, the first pressure chamber being formed between the annular seal, the sealing ring, the shaft, and the housing and being annularly variable.

13. The actuator device as recited in claim 12 wherein the push rod is at least partially disposed within the shaft, and has a transmission element contacting the sealing ring through at least one opening formed in the shaft.

14. The actuator device as recited in claim 11 wherein the push rod has a first push rod shoulder at a first end disposed within the shaft, and the shaft has formed therein a first shaft shoulder, the push rod extending through the first shaft shoulder, and wherein the first pressure chamber is formed between the first push rod shoulder, the first shaft shoulder, the push rod, and the shaft, and being annularly variable.

15. The actuator device as recited in claim 14 wherein the push rod has a second push rod shoulder, and the shaft has formed therein a second shaft shoulder, the push rod extending through the second shaft shoulder, and wherein a second annular variable pressure chamber is formed between the second push rod shoulder, the second shaft shoulder, the push rod, and the shaft.

16. The actuator device as recited in claim 11 further comprising an actuator housing on a side of the drive wheel facing away from the housing, the actuator housing having an opening for at least partially receiving the push rod, and wherein the actuator housing, together with the push rod, forms the first pressure chamber therein.

17. The actuator device as recited in claim 11 wherein the housing, an actuator housing or the shaft has at least one first bore allowing fluid passage therethrough for supplying or discharging the fluid.

18. The actuator device as recited in claim 11 further comprising a spring element for actuating the push rod, the spring element being disposed between the push rod and the shaft or the actuator housing.

19. A coupling mechanism in a drive wheel in a belt drive or chain drive, comprising the actuator device as recited in claim 11.

20. A pump for an internal combustion engine, the pump comprising an actuator device as recited in claim 11.

21. A pump for an internal combustion engine, the pump comprising a coupling mechanism as recited in claim 19.

22. A coolant pump for an internal combustion engine, the pump comprising an actuator device as recited in claim 11.
